(19) United States
(12) Patent Application Publication
(10) Pub. No.: US 2019/0173179 A1
(43) Pub. Date: Jun. 6, 2019

(54) ANTENNA APPARATUS AND VEHICLE INCLUDING THE SAME

(71) Applicants: HYUNDAI MOTOR COMPANY, Seoul (KR); KIA MOTORS CORPORATION, Seoul (KR)

(72) Inventor: Sang Heun LEE, Seoul (KR)

(21) Appl. No.: 16/007,807

(22) Filed: Jun. 13, 2018

(30) Foreign Application Priority Data
Dec. 2, 2017 (KR) 10-2017-0164690

(51) Int. Cl. H01Q 7/00; H01Q 1/32

(52) U.S. Cl. CPC H01Q 7/005; H01Q 1/3275

(57) ABSTRACT

Disclosed herein are an antenna apparatus and a vehicle including the antenna apparatus. The antenna apparatus includes a coil to receive a wireless signal, a switch to adjust an operating range of the coil, an amplifier to amplify the wireless signal received by the coil, and a controller to control the switch to change an operating frequency band of the coil.

### CROSS-REFERENCE TO RELATED APPLICATION

This application is based on and claims priority under 35 U.S.C. § 119 to Korean Patent Application No. 10-2017-0164690, filed on Dec. 2, 2017, in the Korean Intellectual Property Office, the disclosure of which is incorporated by reference herein in its entirety.

### BACKGROUND

### 1. Field

Embodiments of the present disclosure relate to an antenna apparatus and a vehicle including the same.

### 2. Description of Related Art

In general, vehicles include antennas for receiving electric waves, in order to receive radio broadcasting, etc. The antennas for vehicle have high gains at a resonance frequency and low gains at frequencies that are away from the resonance frequency. Typically, in order to compensate for the problem in performance, an amplifier has been installed in an antenna to amplify signal intensities of frequency bands around a resonance frequency. However, the amplifier amplifies the intensity of noise, as well as the signal intensities of the frequency bands around the resonance frequency, which makes improving a Signal-to-Noise Ratio (SNR) difficult.

Also, impedance matching for antennas has been considered in order to optimize power efficiency. However, typical amplifiers have difficulties in implementing impedance matching in consideration of high impedance of antennas, resulting in a waste of power.

The disclosure of this section is to provide background of the invention. Applicant notes that this section may contain information available before this application. However, by providing this section, Applicant does not admit that any information contained in this section constitutes prior art.

### SUMMARY

An aspect of the present disclosure provides an antenna apparatus having an excellent Signal-to-Noise Ratio (SNR) regardless of frequency bands, and a vehicle including the antenna apparatus.

It is another aspect of the present disclosure to provide an antenna apparatus capable of implementing optimal impedance matching for an antenna according to frequencies, and a vehicle including the antenna apparatus.

Additional aspects of the disclosure will be set forth in part in the description which follows and, in part, will be obvious from the description, or may be learned by practice of the disclosure.

In accordance with an aspect of the present disclosure, an antenna apparatus includes a coil to receive a wireless signal, a switch to adjust an operating range of the coil, an amplifier to amplify the wireless signal received by the coil, and a controller to control the switch to change an operating frequency band of the coil.

The switch may be connected to the coil at one of a plurality of locations of the coil, and the operating range of the coil may be adjusted according to a location at which the coil is connected to the switch.

The controller may determine an operating frequency band of the coil based on a frequency selected by a user.

The antenna apparatus may further include a tuner to extract a wireless signal of a frequency selected by a user in synchronization of the selected frequency.

In accordance with another aspect of the present disclosure, an antenna apparatus includes an antenna to receive a wireless signal, an amplifier to amplify the wireless signal received by the antenna, and a controller to control an impedance variation range of the amplifier, and the amplifier includes a switch, a plurality of inductors, and an amplifier circuit, the switch is connected to one of the plurality of inductors according to a control signal from the controller, and the plurality of inductors have different inductance values, and are connected in parallel to the amplifier circuit.

The controller may adjust the impedance variation range of the amplifier such that an impedance matching area for impedance of the antenna exists within the impedance variation range of the amplifier.

The controller may adjust the impedance variation range of the amplifier such that an area corresponding to a frequency selected by a user becomes the impedance matching area.

The antenna apparatus may further include a tuner to extract a wireless signal of a frequency selected by a user in synchronization of the selected frequency.

In accordance with another aspect of the present disclosure, an antenna apparatus includes an antenna including a coil to receive a wireless signal, and a switch to adjust an operating range of the coil, an amplifier to amplify the wireless signal received by the antenna, and a controller to control the switch to change an operating frequency band of the coil, and to control an impedance variation range of the amplifier.

The amplifier may include another switch, a plurality of inductors, and an amplifier circuit, the other switch may be connected to one of the plurality of inductors according to a control signal from the controller, and the plurality of inductors have different inductance values, and are connected in parallel to the amplifier circuit. The switch may be connected to the coil at one of a plurality of locations of the coil, and the operating range of the coil may be adjusted according to a location at which the coil is connected to the switch.

The controller may determine an operating frequency band of the coil based on a frequency selected by a user.

The controller may adjust the impedance variation range of the amplifier such that an impedance matching area for impedance of the antenna exists within the impedance variation range of the amplifier.

The controller may adjust the impedance variation range of the amplifier such that an area corresponding to a frequency selected by a user becomes the impedance matching area.

The antenna apparatus may further include a tuner to extract a wireless signal of a frequency selected by a user in synchronization of the selected frequency.

In accordance with another aspect of the present disclosure, a vehicle includes an antenna including a coil to receive a wireless signal, and a switch to adjust an operating range of the coil, an amplifier to amplify the wireless signal received by the antenna, and a controller to control the switch to change an operating frequency band of the coil, and to control an impedance variation range of the amplifier.

The vehicle may further include an input device to receive information about a frequency selected by a user, and to transfer the information about the selected frequency to the controller, and the controller may determine an operating frequency band of the coil based on the frequency selected by the user.

The vehicle may further include an input device to receive information about a frequency selected by a user, and to transfer the information about the selected frequency to the controller, and the controller may adjust the impedance variation range of the amplifier such that an area corresponding to the frequency selected by the user becomes an impedance matching area.

The vehicle may further include an input device to receive information about a frequency selected by a user, and to transfer the information about the selected frequency to the controller, and a tuner to extract a wireless signal of the frequency selected by the user in synchronization of the selected frequency.

The vehicle may further include a sound portion to output the wireless signal extracted by the tuner as sound.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 shows an example of a vehicle including an antenna apparatus according to an embodiment of the present disclosure.

FIG. 2 shows an example of an interior of the vehicle shown in FIG. 1.

FIG. 3 shows an example of an antenna apparatus.

FIG. 4 is a control block diagram of the antenna apparatus.

FIG. 5 shows an example of a configuration of an antenna apparatus according to an embodiment of the present disclosure, and a table representing operating frequencies according to operating ranges of a coil.

FIGS. 6A to 6D show intensities to frequencies when the antenna apparatus according to an embodiment.

FIG. 7 shows signal intensities to frequencies when the antenna apparatus according to an embodiment.

FIG. 8 is a graph for describing an effect that can be obtained in a strong electric field when the antenna apparatus according to an embodiment.

FIG. 9 is a control block diagram of an antenna apparatus according to an embodiment.

FIG. 10 is a circuit diagram of an amplifier of the antenna apparatus according to an embodiment.

FIGS. 11A-11E show smith charts of complex planes about impedance of the antenna apparatus according to the embodiment of FIG. 10.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

Reference will now be made in detail to the exemplary embodiments of the present disclosure, examples of which are illustrated in the accompanying drawings, wherein like reference numerals refer to like elements throughout.

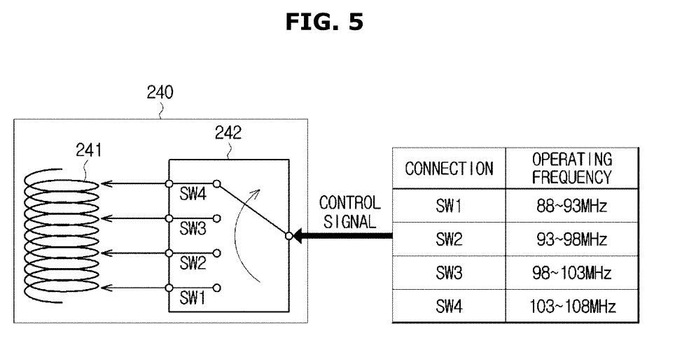

An aspect of the invention provides is an antenna device of vehicle. The device include an internal antenna coil 241 and a signal processing circuit. The device further includes a switch unit 242 for adjusting length of antenna. In embodiments, a portion of the antenna coil 242, between one end of the coil (upper end/terminal of the coil 241 in FIG. 5) and a point of the coil contacting one of the switch, act as a signal receiving antenna. Accordingly, by selecting one of the switches (SW1 to SW4), signal sensing length of the antenna coil can be adjusted. Each of the switches has a corresponding band of operating frequency (corresponding signal amplifying frequency band, table in FIG. 5).

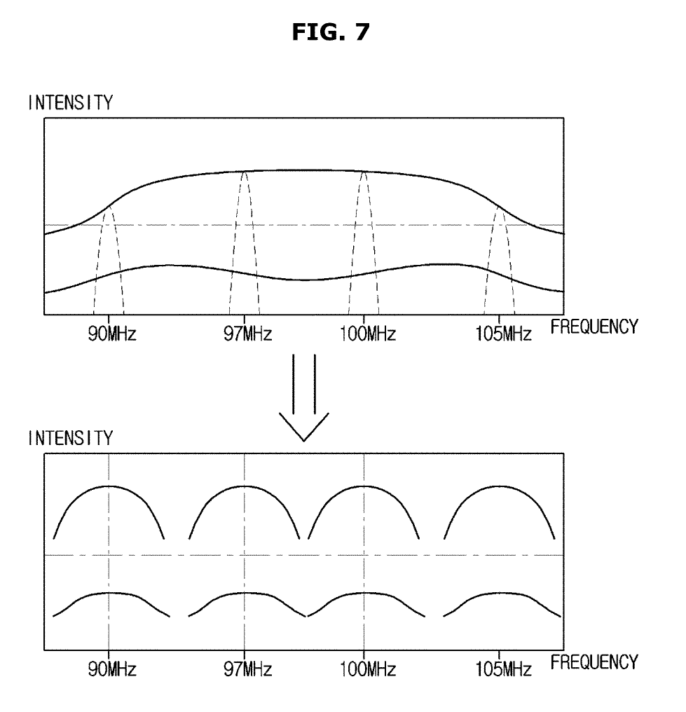

In embodiments, for each switch, the signal processing circuit has a corresponding circuit and/or a corresponding operation parameter such that the signal processing circuit can adjust its signal amplifying frequency (four band characteristic disclosed in the lower drawing in FIG. 7) as selection of switch changes. In embodiments, the signal amplifying frequency bands are separated each other such that signal having a first resonance frequency (90 MHz) of the first band (88-93 MHz corresponding to SW1) is attenuated when the signal processing circuit operates for a second signal amplifying frequency band (93-98 MHz corresponding to SW2, having a second resonance frequency of 97 MHz) neighboring to the first band.

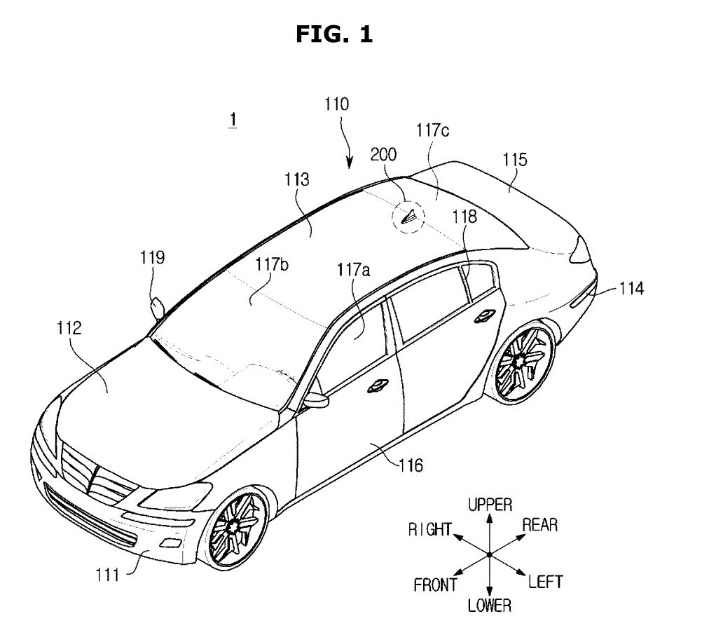

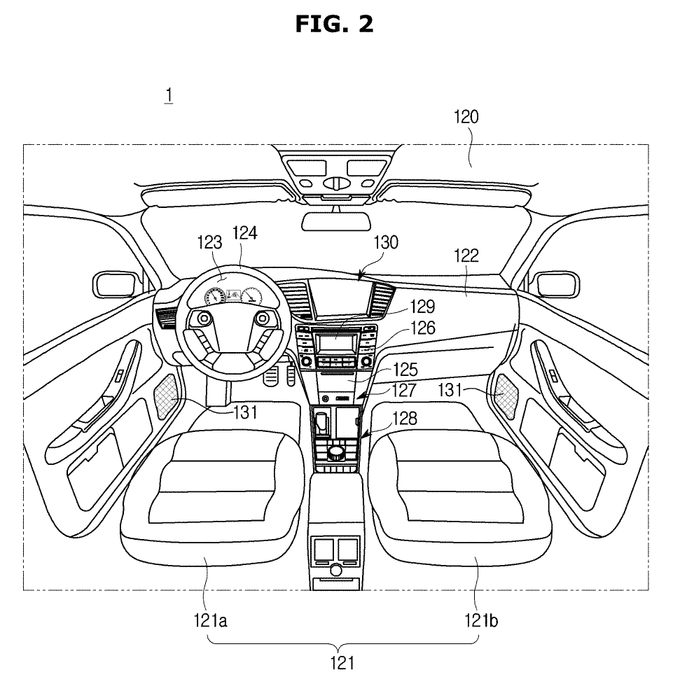

FIG. 1 shows an example of a vehicle including an antenna apparatus according to an embodiment of the present disclosure, and FIG. 2 shows an example of an interior of the vehicle shown in FIG. 1.

A vehicle 1 may drive wheels to move on a road in order to carry persons or goods.

The vehicle 1 may include a body having an interior part and an exterior part, and a chassis which is the remaining part except for the body and in which a mechanical system required for driving is installed.

As shown in FIG. 1, an exterior part 110 of the body may include a front panel 111, a hood 112, a roof panel 113, a rear panel 114, a trunk 115, and front, rear, left, and right doors 116.

Also, the exterior part 110 of the body may further include a plurality of window glasses 117a, 117b, and 117c installed in the front, rear, left, and right doors 116, and a plurality of fillers 118 provided in borders between the front, rear, left, and right glasses 117a, 117b, and 117c.

The window glasses 117a, 117b, and 117c installed in the front, rear, left, and right doors 116 may include a plurality of side window glasses 117a, a front window glass 117b installed in the front part of the vehicle 1, and a rear window glass 117c installed in the rear part of the vehicle 1.

The exterior part 110 of the body may further include a pair of side mirrors 119 to provide a driver with a rear view of the vehicle 1.

The chassis of the vehicle 1 may include a power generation system, a power transfer system, a driving system, a steering system, a brake system, a suspension system, a transmission system, a fuel system, and front, rear, left, and right wheels.

Also, the vehicle 1 may include various safety systems for a driver and passengers' safety.

The safety systems may include an airbag system to ensure a driver and passengers' safety upon collision, and an Electronic Stability Control (ESC) system to avoid loss of control of the vehicle 1 when the vehicle 1 accelerates or corners.

Also, the vehicle 1 may further include a proximity sensor to sense an obstacle or another vehicle existing in the rear or side of the vehicle 1, and a rain sensor to determine whether it rains and to sense an amount of rainfall.

Also, the vehicle 1 may include an Electronic Control Unit (ECU) to control the driving of the power generation system, the power transfer system, the driving system, the steering system, the brake system, the suspension system, the transmission system, the fuel system, the various safety systems, and the sensors.

Also, the vehicle 1 may optionally include electronic apparatuses, such as a hands-free system to improve a driver's convenience, a Global Positioning System (GPS), an audio system, a Bluetooth device, a rear camera, and a terminal charging apparatus, and a High-pass apparatus.

The vehicle 1 may further include a start button for inputting an operation command to a start motor.

That is, when the start button is turned on, the vehicle 1 may operate the start motor to drive an engine that is a power generation system, through the operation of the start motor.

The vehicle 1 may further include a battery electrically connected to a terminal, the audio system, room lamps, the start motor, and other electronic devices to supply operating power to the electronic devices.

The battery may charge the electronic devices using its own generator or engine power during driving.

Also, the vehicle 1 may further include an antenna apparatus 200 installed on the roof panel 113, and configured to receive wireless signals, such as radio signals, broadcasting signals, and satellite signals, and to transmit/receive signals to/from other vehicles, a server, and a base station. FIG. 1 shows a case in which the antenna apparatus 200 is installed on the roof panel 113. However, the antenna apparatus 200 may be installed on the front window glass 117b or the rear window glass 117c of the vehicle 1, and coupled with a glass antenna.

The antenna apparatus 200 will be described in detail, later.

As shown in FIG. 2, an interior 120 of the body may include: a plurality of seats 121 (121a and 121b) in which passengers sit; a dash board 122; an instrument panel (that is, a cluster) 123 which is disposed on the dash board 122 and in which a tachometer, a speed meter, a cooling water thermometer, a fuel gauge, a turn signal indicator, a high beam indicator, an alarm lamp, a seat belt warning lamp, a trip odometer, an odometer, an automatic transmission selection lever indicator, an opening-of-door warning indicator, an engine oil alarm lamp, and a fuel shortage alarm lamp are arranged; a steering wheel 124 to control a movement direction of the vehicle 1; and a center fascia 125 including an audio system and blades of an air conditioner.

The seats 121 may include a driver seat 121a in which a driver sits, a passenger seat 121b in which a passenger sits, and a back seat that is provided in the back part inside the vehicle 1.

The cluster 123 may be implemented in a digital fashion. The cluster 123 implemented in the digital fashion may display vehicle information and driving information in the form of images.

The center fascia 125 may be located in the dashboard 122 between the driver seat 121a and the passenger seat 121b, and include a head unit 126 to control the audio system, the air conditioner, seat heaters, and the like.

The head unit 126 may include a plurality of buttons to receive commands for operating the audio system, the air conditioner, and the seat heaters.

In the center fascia 125, a ventilator, a cigar jack, and the like may be installed, and also, a multi terminal 127 may be installed.

The multi terminal 127 may be disposed adjacent to the head unit 126, and include a Universal Serial Bus (USB) port and an auxiliary (AUX) terminal. The multi terminal 127 may further include a Secure Digital (SD) slot.

The vehicle 1 may further include an input device 128 to receive commands for performing various functions, and a display 128 to display information about a function being performed and information input by a user.

The input device 128 may be mounted on at least one of the head unit 126 or the center fascia 125, and include at least one physical button, such as on/off buttons for executing or stopping various functions, buttons for changing setting values of the various functions, etc.

The input device 128 may transmit button control signals to the ECU, a controller in the head unit 126, or a terminal 130.

The input device 128 may include a touch panel integrated with a display of the terminal 130. The input device 128 may be activated and displayed in the form of buttons on the display of the terminal 130, and in this case, the input device 128 may receive information about locations of the displayed buttons.

The input device 128 may further include a jog dial or a touch pad to enable a user to input commands for moving or selecting a cursor displayed on the display of the terminal 130.

The jog dial or the touch pad may be disposed in the center fascia 125, etc.

When a navigation function is selected, the input device 128 may receive information of a destination, and transmit the information of the destination to the terminal 130, and when a Digital Multimedia Broadcasting (DMB) function is selected, the input device 128 may receive information about a channel and volume, and transmit the information about the channel and volume to the terminal 130.

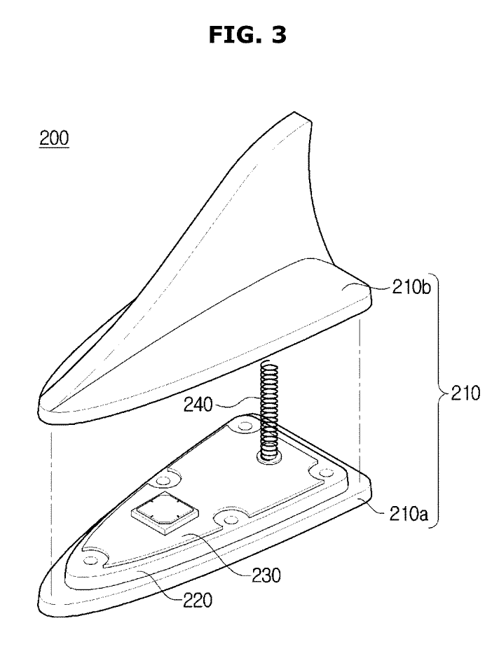

Also, when a radio function is selected, the input device 128 may receive information about a frequency band (for example, a FM frequency band) and a frequency (for example, 89.1 MHz) from a user, and transmit the information about the frequency band and the frequency to the antenna apparatus 200 (see FIG. 3).

On the center fascia 125, the terminal 130 may be mounted to receive information from the user, and to output results corresponding to the received information.

The terminal 130 may perform at least one function among the navigation function, the DMB function, the radio function, an audio function, and a video function, and in an autonomous drive mode, the terminal 130 may display environmental information of roads, driving information, etc.

The terminal 130 may be fixed on the dash board 122.

A sound portion 131 may output sound when the radio function or the audio function is performed. When the radio function is performed, the sound portion 131 may receive a sound signal corresponding to a frequency input by the user from the antenna apparatus 200 which will be described later, and output the received signal for the user.

FIG. 3 shows an example of an antenna apparatus.

As shown in FIG. 3, the antenna apparatus 200 may include a housing 210 including a bottom member 210a installed on the roof panel 113 of the body, and a cover member 210b coupled with the bottom member 210a and covering internal components.

The bottom member 210a may be made of a synthetic resin, and attached on the body to prevent foreign materials from entering between the body and the cover member 210b, while absorbing impacts transferred from the body.

The bottom member 210a may be disposed in the rear, upper portion of the vehicle 1, in order to reduce a risk of interference with peripheral components to improve a reception ratio of radio signals.

Also, the bottom member 210a may have a wider width at the rear portion to reduce the resistance of wind and the generation of noise when the body moves.

The housing 210 may be a shark fin type.

The antenna apparatus 200 may include a base member 220 disposed on the bottom member 210a, and a driving module 230 disposed on the base member 220.

The base member 220 may be coupled with the bottom member 210a by bonding or bolting, and coupled with the driving module 230 by bolting.

The base member 220 may provide space for mounting the driving module 230 and an antenna 240.

The driving module 230 may be a Printed Circuit Board (PCB) having wirings formed by etching copper, etc. on a board.

The driving module 230 may include a hole passing wires therethrough.

The driving module 230 may include a signal processing circuit to process signals received through the antenna 240 by amplifying or filtering the signals.

The driving module 230 may transmit signals to the ECU or the terminal 130 installed in the body.

The driving module 230 may extract broadcasting signals of predetermined frequency bands, for example, FM signals, AM signals, or Digital Audio Broadcasting (DAB)/DMB signals, and optimize the broadcasting signals.

The driving module 230 may be implemented as an integrated reception module by mounting components, such as a Band Pass Filter (BPF), a switch, a tuner, a buffer, and a Digital Signal Processor (DSP), on a circuit board.

One or more antennas 240 may be rested on the driving module 230.

The antenna 240 may be an antenna to receive a signal of a specific frequency band as a signal of a fundamental frequency band. The specific frequency band may be a frequency band of various broadcasting signals, such as a FM band, an AM band, a DAB band, or a DMB band.

The antenna 240 may be rested on the driving module 230 to transfer received signals to the driving module 230.

The antenna 240 may be a coil antenna. Also, the antenna 240 may be a chip antenna, a microstrip patch antenna, etc., although not limited thereto.

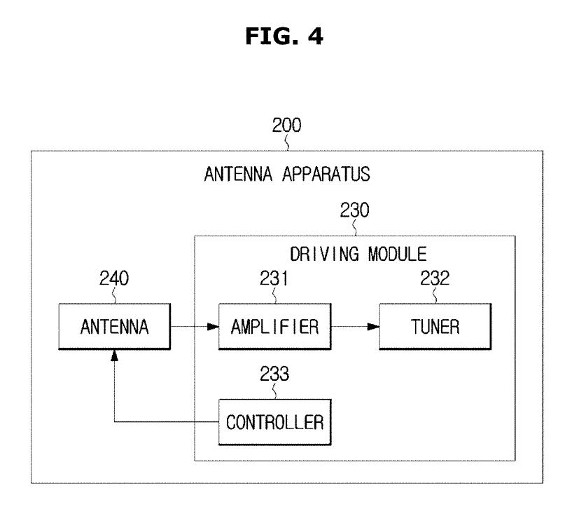

Hereinafter, components of the antenna apparatus 200 will be described with reference to FIG. 4. FIG. 4 is a control block diagram of the antenna apparatus 200.

The antenna apparatus 200 may include the driving module 230 and the antenna 240 described above with reference to FIG. 3.

The driving module 230 may include an amplifier 231, a tuner 232, and a controller 233, and further include a filter to extract a signal of a predetermined frequency band from among signals received by the antenna 240.

The amplifier 231 may amplify a signal received by the antenna 240, and include an amplifier to amplify signals of a frequency band set in advance.

The tuner 232 may extract a signal of a frequency selected by a user in synchronization of the selected frequency.

The tuner 232 may provide the signal of the frequency selected by the user, as a sound signal, to the sound portion 131 of the vehicle 1. The tuner 232 may perform synchronization with a frequency selected through the input device 128 of the vehicle 1 shown in FIG. 2.

The signal extracted by the tuner 232 may be transferred to the sound portion 131 of the vehicle 1, and the sound portion 131 may output the received signal as sound.

The controller 233 may control a frequency band that can be received by the antenna 240, or control an impedance variation range of the amplifier 231.

The controller 233 of the antenna apparatus 200 according to an embodiment may adjust an operating range of a coil included in the antenna 240 to control a frequency band (hereinafter, also referred to as an operating frequency band) that can be received by the antenna 240. The longer length of the coil, the lower operating frequency band of the antenna 240.

The controller 233 of an antenna apparatus 200 according to another embodiment may change a device value of the amplifier 231 to change an impedance variation range of the amplifier 231. In this case, the controller 233 may select a device value of the amplifier 231 to perform impedance matching for the antenna 240.

An antenna apparatus 200 according to still another embodiment may be a combination of the antenna apparatus 200 according to the above-described embodiment and the antenna apparatus 200 according to the other embodiment, and the controller 233 of the antenna apparatus 200 according to the still another embodiment may adjust an operating range of the coil included in the antenna 240, and change a device value of the amplifier 231.

Details about control operations that are performed by the controllers 233 of the antenna apparatuses 200 according to embodiments will be described later.

Also, the controller 233 may generate various control signals for controlling components in the antenna apparatus 200.

The controller 233 may be implemented as a separate module from the driving module 230, or may be integrated into the ECU of the vehicle 1.

The controller 233 may be implemented with a memory to store data about algorithms for controlling the operations of the components of the antenna apparatus 200 or about programs for executing the algorithms, and a processor to perform the above-described operations using the data stored in the memory. The memory and the processor may be implemented as separate chips, or integrated into a single chip.

Also, the controller 233 may transmit signals to the ECU or the terminal 130 described above with reference to FIG. 2. In this case, the controller 233 may transmit the signals using a Controller Area Network (CAN) communication method.

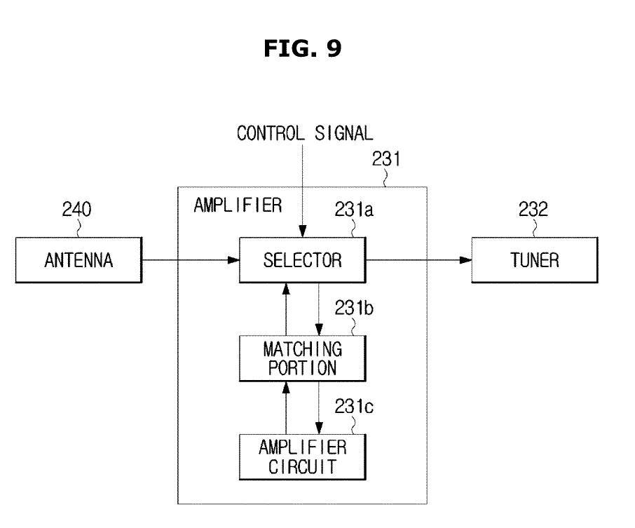

Hereinafter, the antenna apparatus 200 according to an embodiment will be described with reference to FIGS. 5 to 8, and the antenna apparatus 200 according to another embodiment will be described with reference to FIGS. 9 to 11.

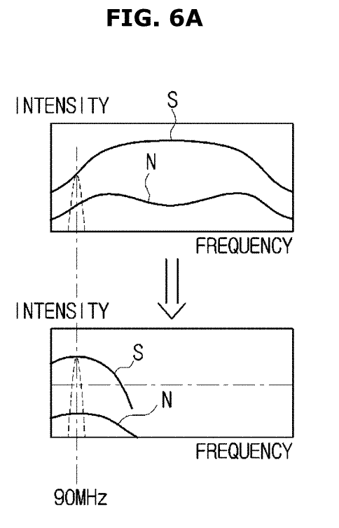

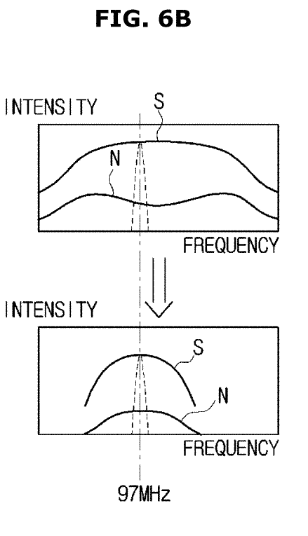

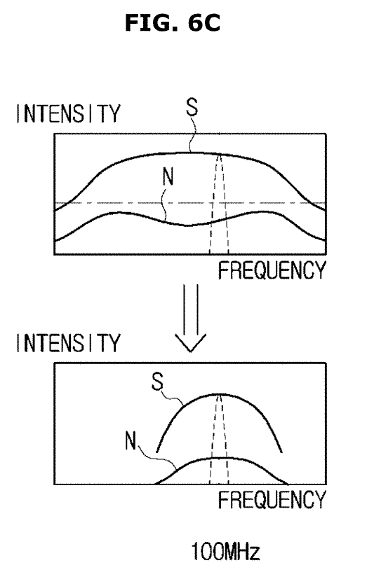

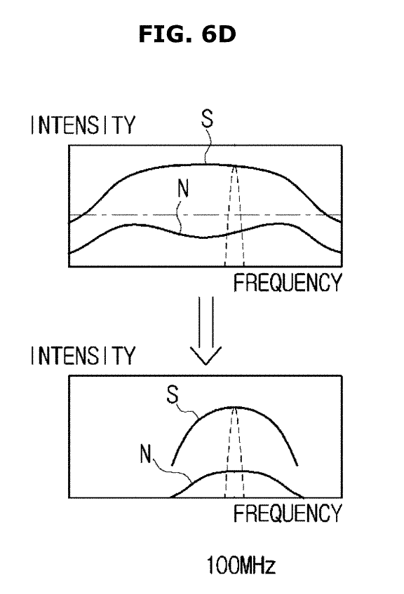

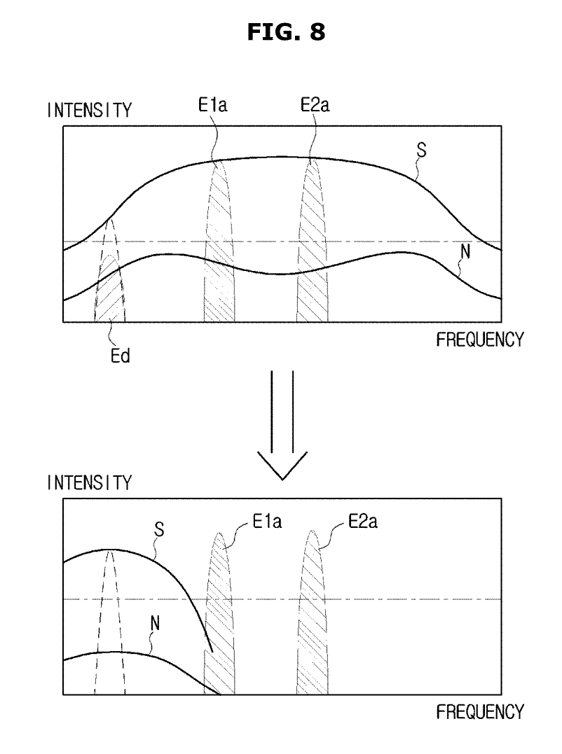

FIG. 5 shows an example of a configuration of an antenna apparatus according to an embodiment of the present disclosure, and a table representing operating frequencies according to operating ranges of a coil, FIGS. 6 and 7 are graphs showing signal intensities to frequencies when the antenna apparatus, and FIG. 8 is a graph for describing an effect that can be obtained in a strong electric field when the antenna apparatus.

The antenna apparatus 200 according to an embodiment may adjust an operating range of the coil included in the antenna 240.

Referring to FIG. 5, the antenna 240 according to an embodiment may include a coil 241 and a switching portion 242.

The coil 241 may operate by current received through the switching portion 242. The longer length of the operating coil 241, that is, the longer length of the coil 241 through which current flows, the lower frequency band that can be received by the antenna 240.

The switching portion 242 may include a switch, and change a location at which it is connected to the coil 241, according to a control signal from the controller 233, thereby changing the length (that is, an operating range of the coil 241) of the operating coil 241. If the operating range of the coil 241 changes, the operating frequency band of the coil 241 may also change accordingly.

For example, as shown in FIG. 5, if the controller 233 locates the switch of the switching portion 242 at a location SW1, the operating frequency band of the coil 241 may become a band of 88 MHz to 93 MHz, and if the controller 233 locates the switch of the switching portion 242 at a location SW2, the operating frequency band of the coil 241 may be reduced to a band of 93 MHz to 98 MHz. If the controller 233 locates the switch of the switching portion 242 at a location SW3, the operating frequency band of the coil 241 may be further reduced to a band of 98 MHz to 103 MHz, and if the controller 233 locates the switch of the switching portion 242 at a location SW4, the operating frequency band of the coil 241 may be further reduced to a band of 103 MHz to 108 MHz.

As seen in FIG. 6, a Signal-to-Noise Ratio (SNR) can be improved compared to a typical antenna apparatus (see the upper graphs of FIG. 6), since the controller 233 changes the operating frequency of the antenna 240.

More specifically, as shown in FIG. 5, if the switch is at the location SW1, the operating frequency band may be a frequency band between 88 MHz and 93 MHz, as shown in (a) of FIG. 6, and a high SNR can be obtained at a frequency of 90 MHz selected by a user, compared to the typical antenna apparatus.

Also, if the switch is at the location SW2, the operating frequency band may be a frequency band between 93 MHz and 98 MHz, as shown in (b) of FIG. 6, and a high SNR can be obtained at a frequency of 97 MHz selected by a user, compared to the typical antenna apparatus.

Also, if the switch is at the location SW3, the operating frequency band may be a frequency band between 98 MHz and 108 MHz, as shown in (c) of FIG. 6, and a high SNR can be obtained at a frequency of 100 MHz selected by a user, compared to the typical antenna apparatus.

Also, if the switch is at the location SW4, the operating frequency band may be a frequency band between 98 MHz and 108 MHz, as shown in (d) of FIG. 6, and a high SNR can be obtained at a frequency of 105 MHz selected by a user, compared to the typical antenna apparatus.

In this way, if the antenna 240 is driven by dividing operating frequency bands, a high SNR can be obtained at a frequency (90 MHz, 97 MHz, 100 MHz, or 105 MHz) selected by a user, compared to the typical technique, as shown in FIG. 7.

The above-described embodiment relates to a case of dividing a frequency band to four operating frequency bands through the controller 233 and the switching portion 242, however, the number of divided operating frequency bands is not limited to four.

Also, as shown in FIG. 8, in a strong electric field, an intermodulation signal Ed may be generated by strong electric field signals E1a and E2a, and signal interference may increase by the intermodulation signal Ed. However, in the antenna apparatus 200 according to the current embodiment, since the antenna 240 operates only at a predetermined frequency, an intermodulation signal Ed can be reduced, resulting in an improvement in reception performance.

Hereinafter, an antenna apparatus 200 according to another embodiment will be described.

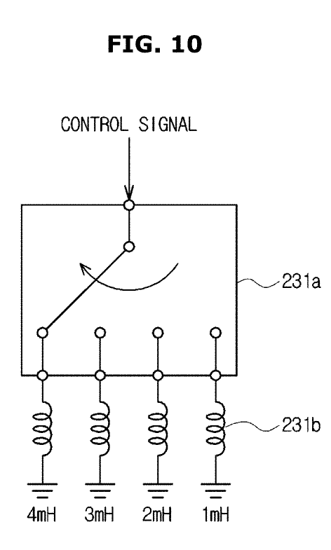

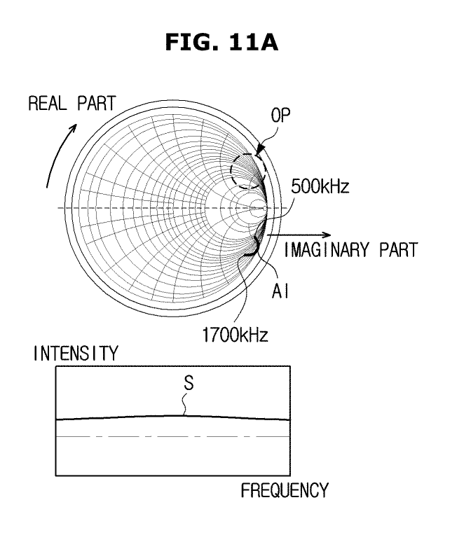

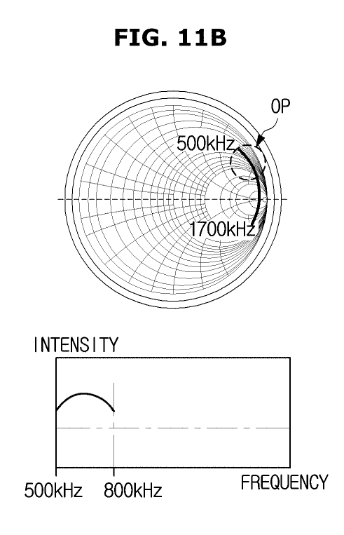

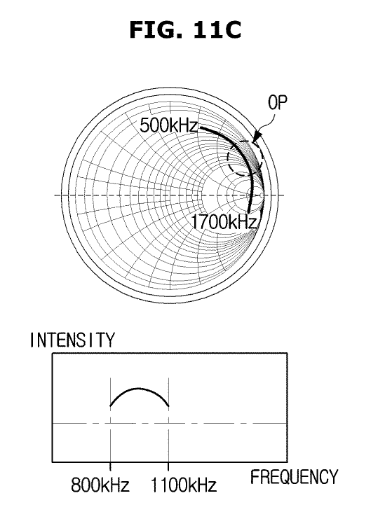

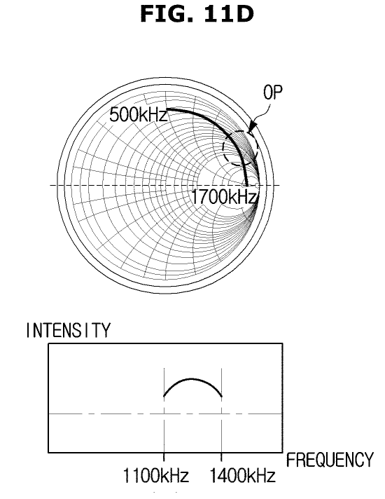

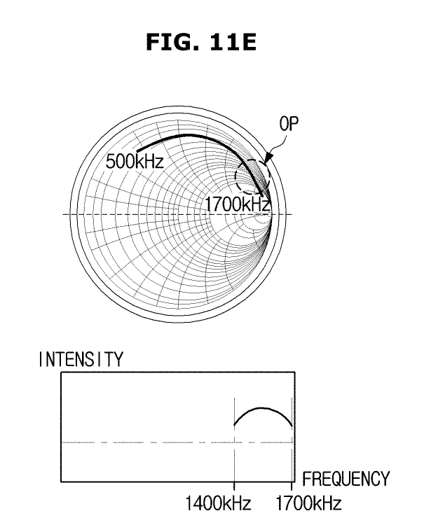

FIG. 9 is a control block diagram of an antenna apparatus according to another embodiment, FIG. 10 is a circuit diagram of an amplifier of the antenna apparatus according to the other embodiment, and FIG. 11 shows smith charts of complex planes about impedance of the antenna apparatus according to the other embodiment.

The antenna apparatus 200 according to another embodiment may adjust an impedance variation range of the amplifier 231 to perform impedance matching for the antenna 240.

The amplifier 231 of the antenna apparatus 200 according to the other embodiment may include a selector 231a and a matching portion 231b to adjust an impedance matching range of an internal amplifier circuit 231c.

The selector 231a may be a switch, and select a location of a connection to the matching portion 231b according to a control signal from the controller 233 to thereby adjust an impedance variation range of the amplifier circuit 231c.

The matching portion 231b may include a plurality of inductors having different inductance values connected in parallel to the amplifier circuit 231c, and when any one inductor of the plurality of inductors is selected by the selector 231a, an impedance variation range of the amplifier circuit 231c may be adjusted.

The amplifier circuit 231c may be a general circuit for amplifying signal intensity, which is well-known in the related art, and accordingly, detailed descriptions thereof will be omitted.

For example, as shown in FIG. 10, the controller 233 may control the selector 231a to connect the amplifier circuit 231c to any one of the plurality of inductors of the matching portion 231b, and any one inductor may be selected according to the control of the controller 233 to control an impedance variation range of the amplifier circuit 231c.

In this case, the controller 233 may change the impedance variation range of the amplifier circuit 231c based on a frequency selected by a user.

More specifically, as shown in (a) of FIG. 11, when impedance Al of the antenna 240 is R+jX at an entire frequency band of 500 kHz to 1700 kHz at which the antenna 240 can operate, ideal impedance (hereinafter, an impedance matching area op) of the amplifier 231 for impedance matching may need to become R-jX which is the conjugate complex number.

As the inductance of a selected inductor is smaller, the impedance variation range of the amplifier 231 at 500 kHz to 1700 kHz becomes more distant from the impedance Al of the antenna 240 on the upper end trajectory of FIG. 11. Also, a frequency band corresponding to the impedance matching area op may increase (in FIG. 11, a frequency band corresponding to the impedance matching area op increases to 500 kHz to 800 kHz when an inductor of 4 mH is selected, to 800 kHz to 1100 kHz when an inductor of 3 mH is selected, to 1100 kHz to 1400 kHz when an inductor of 2 mH is selected, and to 1400 kHz to 1700 kHz when an inductor of 1 mH is selected).

Accordingly, the controller 233 of the antenna apparatus 200 according to the other embodiment can adjust the impedance variation range of the amplifier 231 such that a frequency selected by a user exists within the impedance matching area op. That is, the controller 233 can adjust the impedance variation range of the amplifier 231 such that an area corresponding to a frequency selected by a user within the impedance variation range of the amplifier 231 becomes the impedance matching area op.

For example, if it is determined that a frequency selected by a user is between 500 kHz and 800 kHz, the controller 233 may change the impedance variation range of the amplifier 231 at 500 kHz to 1700 kHz (that is, an entire frequency band that can be received by the antenna 240), as shown in the upper end of (b) of FIG. 11, and accordingly, the impedance of the amplifier 231 at 500 kHz to 800 kHz can exist within the impedance matching area op.

Also, if it is determined that a frequency selected by the user is between 800 kHz and 1100 kHz, the controller 233 may change the impedance variation range of the amplifier 231 at 500 kHz to 1700 kHz, as shown in the upper end of (c) of FIG. 11, and accordingly, the impedance of the amplifier 231 at 800 kHz to 1100 kHz can exist within the impedance matching area op.

Also, if it is determined that a frequency selected by the user is between 1100 kHz and 1400 kHz, the controller 233 may change the impedance variation range of the amplifier 231 at 500 kHz to 1700 kHz, as shown in the upper end of (d) of FIG. 11, and accordingly, the impedance of the amplifier 231 at 1100 kHz to 1400 kHz can exist within the impedance matching area op.

Also, if it is determined that a frequency selected by the user is between 1400 kHz and 1700 kHz, the controller 233 may change the impedance variation range of the amplifier 231 at 500 kHz to 1700 kHz, as shown in the upper end of (e) of FIG. 11, and accordingly, the impedance of the amplifier 231 at 1400 kHz to 1700 kHz can exist within the impedance matching area op.

The above-described embodiment relates to a case in which an entire frequency band that can be received by the antenna 240 is from 500 kHz to 1700 kHz, however, the entire frequency band that can be received by the antenna 240 is not limited to this.

Also, the above-described embodiment relates to a case in which a frequency selected by a user is determined based on a frequency band from 500 kHz to 800 kHz, a frequency band from 800 kHz to 1100 kHz, a frequency band from 1100 kHz to 1400 kHz, and a frequency band from 1400 kHz to 1700 kHz by the controller 233. However, the controller 233 may determine a frequency selected by a user based on other various frequency bands.

The frequency selected by the user may be a frequency selected through the input device 128 of the vehicle 1 shown in FIG. 2.

The antenna apparatus 200 according to another embodiment may include the antenna 240 having the coil 241 (see FIG. 5) and the switching portion 242 (see FIG. 5) of the antenna apparatus 200 according to an embodiment, and also include the amplifier 231 having the selector 231a (see FIG. 9), the matching portion 231b (see FIG. 9), and the amplifier circuit 231c (see FIG. 9) according to the other embodiment. Descriptions about the amplifier 231, the tuner 232, the controller 233, and the antenna 240 have been given above, and accordingly, further descriptions thereof will be omitted.

According to embodiments, it is possible to improve a SNR for reception signals of the antenna regardless of frequency bands.

Also, according to embodiments, it is possible to realize optimal power efficiency for the antenna apparatus regardless of the impedance of the antenna.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. An antenna apparatus comprising:
a coil configured to receive a wireless signal;
a switch configured to adjust an operating range of the coil;
an amplifier configured to amplify the wireless signal received by the coil; and
a controller configured to control the switch to change an operating frequency band of the coil.

2. The antenna apparatus according to claim 1, wherein the switch is connected to the coil at one of a plurality of locations of the coil, and
the operating range of the coil is adjusted according to a location at which the coil is connected to the switch.

3. The antenna apparatus according to claim 1, wherein the controller determines an operating frequency band of the coil based on a frequency selected by a user.

4. The antenna apparatus according to claim 1, further comprising a tuner configured to extract a wireless signal of a frequency selected by a user in synchronization of the selected frequency.

5. An antenna apparatus comprising:
an antenna configured to receive a wireless signal;
an amplifier configured to amplify the wireless signal received by the antenna; and
a controller configured to control an impedance variation range of the amplifier,
wherein the amplifier comprises a switch, a plurality of inductors, and an amplifier circuit,
the switch is connected to one of the plurality of inductors according to a control signal from the controller, and
the plurality of inductors have different inductance values, and are connected in parallel to the amplifier circuit.

6. The antenna apparatus according to claim 5, wherein the controller adjusts the impedance variation range of the amplifier such that an impedance matching area for impedance of the antenna exists within the impedance variation range of the amplifier.

7. The antenna apparatus according to claim 6, wherein the controller adjusts the impedance variation range of the amplifier such that an area corresponding to a frequency selected by a user becomes the impedance matching area.

8. The antenna apparatus according to claim 5, further comprising a tuner configured to extract a wireless signal of a frequency selected by a user in synchronization of the selected frequency.

9. An antenna apparatus comprising:
an antenna including a coil configured to receive a wireless signal, and a switch configured to adjust an operating range of the coil;
an amplifier configured to amplify the wireless signal received by the antenna; and
a controller configured to control the switch to change an operating frequency band of the coil, and to control an impedance variation range of the amplifier.

10. The antenna apparatus according to claim 9, wherein the amplifier comprises another switch, a plurality of inductors, and an amplifier circuit,
the other switch is connected to one of the plurality of inductors according to a control signal from the controller, and
the plurality of inductors have different inductance values, and are connected in parallel to the amplifier circuit.

11. The antenna apparatus according to claim 9, wherein the switch is connected to the coil at one of a plurality of locations of the coil, and
the operating range of the coil is adjusted according to a location at which the coil is connected to the switch.

12. The antenna apparatus according to claim 9, wherein the controller determines an operating frequency band of the coil based on a frequency selected by a user.

13. The antenna apparatus according to claim 9, wherein the controller adjusts the impedance variation range of the amplifier such that an impedance matching area for impedance of the antenna exists within the impedance variation range of the amplifier.

14. The antenna apparatus according to claim 13, wherein the controller adjusts the impedance variation range of the amplifier such that an area corresponding to a frequency selected by a user becomes the impedance matching area.

15. The antenna apparatus according to claim 9, further comprising a tuner configured to extract a wireless signal of a frequency selected by a user in synchronization of the selected frequency.

16. A vehicle comprising:
an antenna including a coil configured to receive a wireless signal, and a switch configured to adjust an operating range of the coil;
an amplifier configured to amplify the wireless signal received by the antenna; and
a controller configured to control the switch to change an operating frequency band of the coil, and to control an impedance variation range of the amplifier.

17. The vehicle according to claim 16, further comprising an input device configured to receive information about a frequency selected by a user, and to transfer the information about the selected frequency to the controller, and
wherein the controller determines an operating frequency band of the coil based on the frequency selected by the user.

18. The vehicle according to claim 16, further comprising an input device configured to receive information about a frequency selected by a user, and to transfer the information about the selected frequency to the controller, and
wherein the controller adjusts the impedance variation range of the amplifier such that an area corresponding to the frequency selected by the user becomes an impedance matching area.

19. The vehicle according to claim 16, further comprising:
an input device configured to receive information about a frequency selected by a user, and to transfer the information about the selected frequency to the controller; and
a tuner configured to extract a wireless signal of the frequency selected by the user in synchronization of the selected frequency.

20. The vehicle according to claim 19, further comprising a sound portion configured to output the wireless signal extracted by the tuner as sound.
